(19) United States
(12) Patent Application Publication
(10) Pub. No.: US 2005/0039016 A1
(43) Pub. Date: Feb. 17, 2005

(54) Method for using trusted, hardware-based identity credentials in runtime package signature to secure mobile communications and high-value transaction execution

(76) Inventors: Selim Aissi, Beaverton, OR (US); David Wheeler, Chandler, AZ (US); Krishnamurthy Srinivasan, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/639,903

(22) Filed: Aug. 12, 2003

(51) Int. Cl. H04L 9/00

(52) U.S. Cl. 713/176

(57) ABSTRACT

A method for trusted package digital signature based on secure, platform-bound identity credentials. The selection of a document to be electronically signed by a user via a computing device is made. A hash for the document is determined. The hash is encrypted with a private key of the user to create a digital signature. The document, an identification credential, and the digital signature are sent to a recipient computing device residing on a network. The identification credential comprises a digital file used to cryptographically bind a public key to specific trusted hardware attributes attesting to the identity and integrity of the trusted computing device. The trusted computing device includes a cryptographic processor.

### BACKGROUND OF THE INVENTION

1. Field of the Invention

The present invention is generally related to the field of mobile communications. More particularly, the present invention is related to a method for using trusted, hardware-based credentials in runtime package signature and secure mobile communications.

2. Description

In several countries where GSM (Global System for Mobile Communications) networks are available, such as, for example, Japan, cell phone users can use their cell phones to make small business transactions. This is referred to as mCommerce or mobile eCommerce. The business transactions may include, but are not limited to, such things as buying bottled water, sodas, and other items from vending machines, paying for parking lot fees, etc. The leading technology that provides such transactions over wireless networks is called iMode, a mobile internet access system trademarked and/or service mark owned by NTT DoCoMo, a subsidiary of Japan's incumbent telephone operator NTT. iMode works well with low-priced business transactions, but a higher level of security and trustworthiness is necessary for cell phones and wireless personal digital assistants (PDAs) today to enable high priced business transactions over wireless networks.

A major inhibitor in using this technology to provide mCommerce on more expensive transactions is the lack of security or trustworthiness in the exchange of digital signatures using a public key infrastructure. Public key infrastructures employ digital certificates, which can be obtained from Certificate Authorities. The digital certificates adhere to a Public-Key Infrastructure (x.509 or pkix), www.ieff.org/html.charters/pkix-charter.html, last modified Apr. 21, 2003. Although it is necessary that credentials prove various pieces of information, the full capabilities of x.509 result in a file format that is much too large in size for use on mobile devices. Mobile devices are limited by the memory size, storage capacity, and the speed of existing mobile processors.

Also, storage capabilities are not secure enough. For example, it is known where digital certificate files are stored in memory so if an owner misplaces their mobile device and the mobile device ends up in the hands of an untrustworthy person with the ability to access the digital certificates, the untrustworthy person may have the ability to exploit them by either installing forged certificates or by modifying the existing certificates with their own credentials (e.g., name).

Also, present day certificates are only as good as their origin and their delegation chain. Self-signed certificates can be generated “on-the-fly” by existing software tools, such as Java's Keytool (manufactured by Sun Microsystems, Inc.), which adds the risk of using a fake certificate if the certificate generator has been compromised. In other instances, malicious replacement of the Java Security Manager classes and related security tools, such as the Keytool, have resulted in certificate forgery and theft.

Thus, what is needed is a method for providing digital signatures using a certificate format that is both secure and more amenable to mobile devices which have limited memory, storage, and processing capabilities. What is also needed is a method for providing runtime digital signatures that is secure and trustworthy to enable high value mCommerce as well as mobile communications between trusted platforms.

### BRIEF DESCRIPTION OF THE DRAWINGS

The accompanying drawings, which are incorporated herein and form part of the specification, illustrate embodiments of the present invention and, together with the description, further serve to explain the principles of the invention and to enable a person skilled in the pertinent art(s) to make and use the invention. In the drawings, like reference numbers generally indicate identical, functionally similar, and/or structurally similar elements. The drawing in which an element first appears is indicated by the leftmost digit(s) in the corresponding reference number.

FIG. 1 is a flow diagram illustrating an exemplary method for assembly-signature service using trusted hardware-based credentials according to an embodiment of the present invention.

FIG. 2 is a flow diagram describing an exemplary method for authenticating assembly-signature using trusted hardware-based credentials according to an embodiment of the present invention.

FIG. 3 is a diagram illustrating an exemplary identification credential according to an embodiment of the present invention.

FIG. 4 is a flow diagram illustrating an exemplary method for generating an identification credential according to an embodiment of the present invention.

### DETAILED DESCRIPTION

While the present invention is described herein with reference to illustrative embodiments for particular applications, it should be understood that the invention is not limited thereto. Those skilled in the relevant art(s) with access to the teachings provided herein will recognize additional modifications, applications, and embodiments within the scope thereof and additional fields in which embodiments of the present invention would be of significant utility.

Reference in the specification to “one embodiment”, “an embodiment” or “another embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

Embodiments of the present invention are directed to a method for using trusted, hardware-based credentials in runtime assembly-signature and secure mobile communications. This is accomplished by employing a cryptographic processor within a mobile device. The cryptographic processor provides security services, including, but not limited to, symmetric (i.e., using the same key to encrypt and decrypt a message) and asymmetric (i.e., using a public key to encrypt a message and a private key to decrypt the message) crypto capabilities, hashing capabilities, and secure storage for keys as well as platform integrity metrics. The trusted hardware-based credentials are used to generate a new type of identity, called the identification credential. The identification credential may only be used by trusted parties in a wireless network. By extending the security capabilities of runtimes with trusted hardware-based credentials, the trustworthiness of mobile communications is improved.

Embodiments of the present invention employ digital signatures based on trusted hardware credentials (e.g., the identification credential) rather than personal credentials. While today's digital certificates (e.g., X.509) require the binding of a user's credentials (e.g., name) to a public key, the trusted hardware-based credentials are bound to a trusted hardware platform, such as, for example, a mobile phone, and are therefore harder to forge than user-based credentials.

Embodiments of the trusted hardware-based credential format may be used by runtime environments, such as, but not limited to, Java's JRE (Java Runtime Environment), .NET's CLR (Common Language Runtime), etc., to sign various types of documents, such as, but not limited to, assembly files, JAR (Java™ Archive) files, XML (extensible Markup Language) files, etc. The digital signature of such documents provides confidentiality, integrity, and non-repudiation to enhance the security of high-value transactions over wireless networks. For example, the information within the document may only be read and understood by the sender and the intended receiver. The information within the document may not be tampered with accidentally or deliberately when in route without all parties involved being aware of the tampering. Also, the sender may not deny sending the message or transaction and the receiver may not deny receiving the message or transaction.

Although embodiments of the present invention are described with respect to mobile devices, trusted hardware-based credentials in runtime assembly-signature may be used with any device that includes a cryptographic processor and/or other trusted hardware and software components. For example, trusted hardware-based credentials may be used by trusted desktops and laptops that include security hardware over wired networks (e.g., local area networks and wide area networks) as well.

An assembly is a file at which security permissions are requested and granted. An assembly is also indicative of the level at which identity and trust are established. Signing an assembly ensures name uniqueness and prevents substituting another assembly with the same name for the assembly that one has provided. By using a hardware-based, trusted identification credential to sign an assembly, applications that use that assembly have the ability to verify the identity of the assembly's developer by using a public and/or private trust hierarchy. Having a runtime identification credential based on trusted hardware, such as a cryptographic processor, effectively strengthens the identity of a runtime assembly by confirming, with a high privacy guarantee, that a particular device is a trusted device that can attest to various components of the mobile device (e.g., the BIOS (Basic Input/Output System) and other hardware within the device) and the configuration of the device, thereby ensuring that the report may be trusted. Providing a hardware-rooted source of trust in a mobile device enables high-value mCommerce to operate in a trustworthy manner.

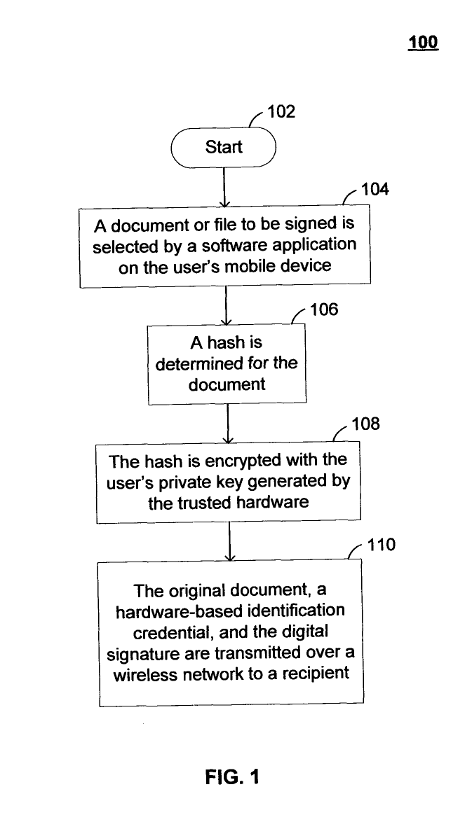

FIG. 1 is a flow diagram 100 illustrating an exemplary method for assembly-signature using trusted hardware-based credentials according to an embodiment of the present invention. The invention is not limited to the embodiment described herein with respect to flow diagram 100. Rather, it will be apparent to persons skilled in the relevant art(s) after reading the teachings provided herein that other functional flow diagrams are within the scope of the invention. The process begins with block 102, where the process immediately proceeds to block 104.

In block 104, a document or file to be signed is selected by a software application running on the user's mobile device. The cryptographic processor within the mobile device determines a hash in block 106. In one embodiment, the document is applied to a publicly known mathematical hashing function that converts the document into a unique number (referred to as the hash) that is hard to reproduce.

In block 108, the hash is encrypted with the user's private key, also known as the signing key, to create a digital signature.

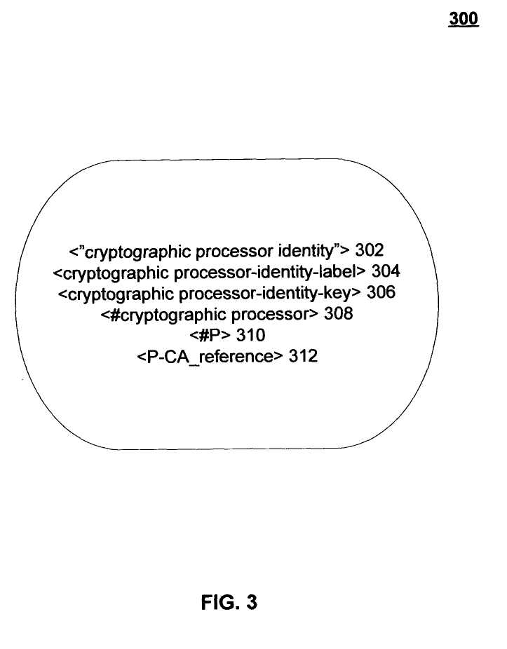

In block 110, the original document, an identification credential, and the digital signature are transmitted over a wireless network to a recipient. The identification credential is a digital file used to cryptographically bind a mobile device's public key to specific trusted hardware attributes that provide strong binding to the identity of the user's trusted mobile device. In one embodiment, the identification credential may also include information relating to the identity of the user as well. Thus, the identification credential binds the public key to information about specific trusted hardware in the mobile device, such as, but not limited to, the cryptographic processor. In one embodiment, the identification credential may bind the public key to information about specific trusted software and/or hardware components in the mobile device as well. The identification credential will be described in detail below with respect to FIG. 3.

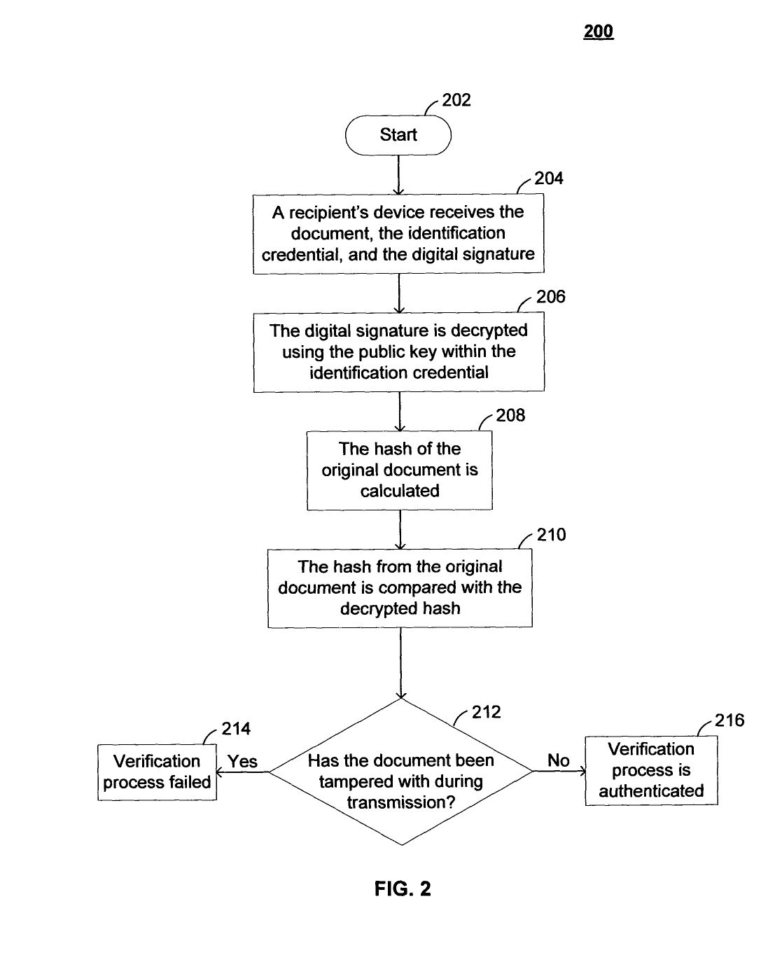

FIG. 2 is a flow diagram 200 describing an exemplary method for authenticating assembly-signature using trusted hardware-based credentials according to an embodiment of the present invention. The invention is not limited to the embodiment described herein with respect to flow diagram 200. Rather, it will be apparent to persons skilled in the relevant art(s) after reading the teachings provided herein that other functional flow diagrams are within the scope of the invention. The process begins with block 202, where the process immediately proceeds to block 204.

In block 204, a recipient's device, such as, but not limited to, a computer, receives the document, the identification credential, and the digital signature. The document is then identified as being signed to notify the computer that the digital signature must be verified.

In block 206, the computer decrypts the digital signature using the public key. In block 208, the hash of the original document is calculated. The mathematical function employed by the user in generating the hash is publicly known.

In block 210, the computer compares the hash it has computed from the received document with the now decrypted hash received from the document. In decision block 212, it is determined whether the document has been tampered with during transmission. If the document has been tampered with during transmission, the two hashes will be different and the process then proceeds to block 214, where the verification process is indicated as having failed.

Returning to decision block 212, if it is determined that the document has not been tampered with during transmission, the two hashes will be identical and the process then proceeds to block 216, where the verification process is indicated as being authenticated.

FIG. 3 is a diagram illustrating an exemplary identification credential 300 according to an embodiment of the present invention. Identification credential 300 is hardware-based for secure control over assembly-signature. In comparison to digital certificates, which are formatted according to an x.509 standard, identification credential 300 utilizes a light-weight format (i.e., much smaller in size than digital certificates) to accommodate the limitations of processor speed, memory and storage allocation, etc. in mobile devices. The combination of the light-weight format of identification credential 300 and the fact that it is bound to a trusted platform, such as the user's mobile device, offers a very useful tool for enabling high-value mCommerce on mobile devices.

As shown in FIG. 3, identification credential 300 is illustrated using an XML (extensible Markup Language) format. Although shown in XML format, identification credential 300 is not limited to an XML format. Those skilled in the relevant art(s) will know that other formats, such as, but not limited to, SOAP (Simple Object Access Protocol) and SAML (Security Assertion Markup Language), etc., may also be used.

Identification credential 300 comprises a cryptographic processor identity 302. Cryptographic processor identity 302 includes the public key. Cryptographic processor identity 302 comprises an identity label 304 and an identity key 306.

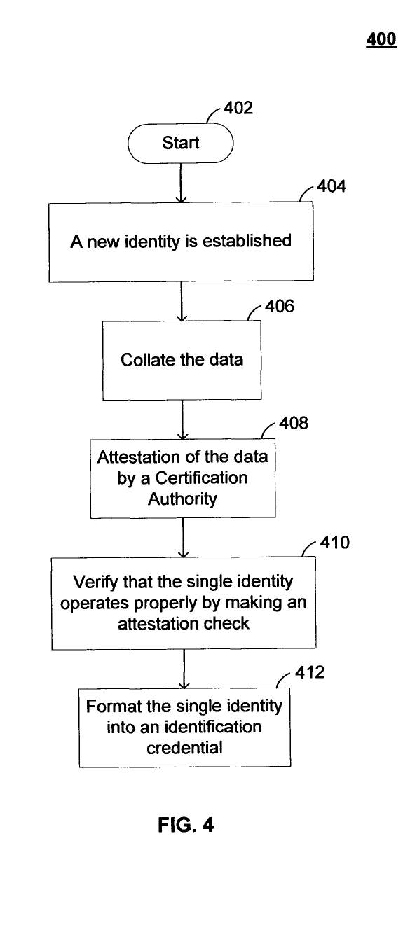

Identification credential 300 also comprises a general description of the cryptographic processor and its security services, identified in FIG. 3 as <#cryptographic processor> 308. The information within <#cryptographic processor> 308 is copied from an endorsement certificate (which will be described below with reference to FIG. 4).

Identification credential 300 also includes a general description of a platform/device and its security properties 310, identified in FIG. 3 as <#P> 310. The information within <#P> 310 is copied from a platform certificate (which will be described below with reference to FIG. 4). <#P> 310 further includes a Certification Authority (CA) used to attest to the identity of identification credential 300. The use of CAs for trusted identification purposes is well known.

FIG. 4 is a flow diagram 400 illustrating a method for generating identification credential 300 according to an embodiment of the present invention. The invention is not limited to the embodiment described herein with respect to flow diagram 400. Rather, it will be apparent to persons skilled in the relevant art(s) after reading the teachings provided herein that other functional flow diagrams are within the scope of the invention. The method for generating identification credential 300 is mainly performed using the cryptographic processor and a trusted software stack within the cryptographic processor. The process begins with block 402, where the process immediately proceeds to block 404.

In block 404, a new hardware-based identity is established. In one embodiment, the establishment of the new identity is performed using an application programming interface or API. The establishment of the new identity is an initiation process in which manufacturers of the trusted hardware or third party testing laboratories provide various certificates indicating that the trusted hardware conforms to the Trusted Computing Platform Alliance or TCPA standard, Main Specification Version 1.1b, www.trustedcomputing.org/docs/main %20v1_{—}1b.pdf (2002). In one embodiment, the certificates are appended to the trusted hardware. All of the certificates are then bound into a single identity.

One such certificate is a public key certificate, also known as an Endorsement Certificate. The Endorsement Certificate is issued by the entity that endorsed the cryptographic processor. The Endorsement Certificate includes, but is not limited to, a NULL subject and the public key of the cryptographic public endorsement identity.

Another certificate is the Platform Credential. The Platform Credential includes a pointer to the endorsement certificate that uniquely identifies the endorser of the platform and the model (i.e., the revision of the hardware and software for the cryptographic processor).

Yet another certificate is the Conformance Credential. The Conformance Credential asserts that the named cryptographic processor complies with the TCPA specification.

Once the certificates are bound into a single hardware-based identity, the information within the single identity includes, but is not limited to, an identification of the cryptographic processor, an identification key, information about the cryptographic processor, such as security properties, hashing properties, etc.

In block 406, all of the data gathered in block 404 is collated. In other words, the data is collected and collated.

In block 408, an independent, trusted third party, such as a Certification Authority (CA), receives the collated data and attests to its identity. In block 410, an attestation check is made to verify that the single identity operates properly.

In block 412, the single identity is formatted into identification credential 300 displayed in FIG. 3. Again, identification credential 300 uses hardware-based, trusted credentials to improve the trustworthiness of mobile communications.

Certain aspects of embodiments of the present invention may be implemented using hardware, software, or a combination thereof and may be implemented in one or more computer systems or other processing systems. In fact, in one embodiment, the methods may be implemented in programs executing on programmable machines such as mobile or stationary computers, personal digital assistants (PDAs), set-top boxes, cellular telephones, and other electronic devices that each include a processor, a cryptographic coprocessor, a storage medium readable by the processor and the coprocessor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that embodiments of the invention may be practiced with various computer system configurations, including multiprocessor systems, minicomputers, mainframe computers, and the like. Embodiments of the present invention may also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the methods described herein. Alternatively, the methods may be performed by specific hardware components that contain hardwired logic for performing the methods, or by any combination of programmed computer components and custom hardware components. The methods described herein may be provided as a computer program product that may include a machine readable medium having stored thereon instructions that may be used to program a processing system or other electronic device to perform the methods. The term “machine readable medium” or “machine accessible medium” used herein shall include any medium that is capable of storing or encoding a sequence of instructions for execution by the machine and that causes the machine to perform any one of the methods described herein. The terms “machine readable medium” and “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system to cause the processor to perform an action or produce a result.

While various embodiments of the present invention have been described above, it should be understood that they have been presented by way of example only, and not limitation. It will be understood by those skilled in the art that various changes in form and details may be made therein without departing from the spirit and scope of the invention as defined in the appended claims. Thus, the breadth and scope of the present invention should not be limited by any of the above-described exemplary embodiments, but should be defined in accordance with the following claims and their equivalents.

1. A method for assembly-signature comprising:
enabling selection of a document to be electronically signed by a user via a trusted computing device;
calculating a hash for the document;
encrypting the hash with a private key of the user to create a digital signature; and
sending the document, an identification credential, and the digital signature to a recipient computing device, wherein the identification credential comprises a digital file used to cryptographically bind a public key to specific trusted hardware attributes relating to the identity of the trusted computing device, and wherein the recipient computing device resides on a network.

2. The method of claim 1, wherein the trusted computing device comprises a mobile device.

3. The method of claim 2, wherein the trusted mobile device comprises at least one of a trusted mobile computing device, a trusted cellular phone, a trusted personal digital assistant (PDA), and a trusted laptop.

4. The method of claim 1, wherein the identification credential comprises a cryptographic processor identity having an identification label and an identification key.

5. The method of claim 1, wherein the identification credential comprises a general description of a cryptographic processor and the security services offered by the cryptographic processor.

6. The method of claim 1, wherein the identification credential comprises a general description of a trusted platform/device and security properties for the trusted platform/device.

7. The method of claim 6, wherein the general description of the trusted platform/device and the security properties includes a name of a Certification Authority used to attest to the identity of the identification credential.

8. An article comprising: a secure storage medium having a plurality of machine accessible instructions, wherein when the instructions are executed by a processor, the instructions provide for enabling selection of a document to be electronically signed by a user via a trusted computing device;
calculating a hash for the document;
encrypting the hash with a private key of the user to create a digital signature; and
sending the document, an identification credential, and the digital signature to a recipient computing device, wherein the identification credential comprises a digital file used to cryptographically bind a public key to specific trusted hardware attributes relating to the identity of the trusted computing device, and wherein the recipient computing device resides on a network.

9. The article of claim 8, wherein the trusted computing device comprises a trusted mobile device.

10. The article of claim 9, wherein the trusted mobile device comprises at least one of a trusted mobile computing device, a trusted cellular phone, a trusted personal digital assistant (PDA), and a trusted laptop.

11. The article of claim 8, wherein the identification credential comprises a cryptographic processor identity having an identification label and an identification key.

12. The article of claim 8, wherein the identification credential comprises a general description of a cryptographic processor and the security services offered by the cryptographic processor.

13. The article of claim 8, wherein the identification credential comprises a general description of a trusted platform/device and security properties for the trusted platform/device.

14. The article of claim 8, wherein the general description of the trusted platform/device and the security properties includes a name of a Certification Authority used to attest to the identity of the identification credential.

15. A method for generating an identification infrastructure comprising:
establishing a single new identity based on trusted hardware components, wherein the single new identity comprises certificates bound together, wherein the certificates indicate that the trusted hardware components conform to a Trusted Computing Platform Alliance (TCPA) standard;
collecting and collating all of the data for the single new identity;
sending the collated data to a Certification Authority to attest to the identity of the data;
performing an attestation check on the data to verify the operation of the single new identity; and
formatting the single new identity into an identification credential, wherein the identification credential is based on trusted hardware to improve the trustworthiness and security of network communications.

16. The method of claim 15, wherein the certificates comprise an endorsement certificate having a public key of a cryptographic public endorsement identity for a cryptographic processor, the cryptographic processor being one component of the trusted hardware components;
a platform credential certificate, the platform credential certificate including a pointer to the endorsement certificate that identifies an endorser of a platform and a platform model of the platform, wherein the platform comprises a component of the trusted hardware components; and
a conformance credential certificate, the conformance credential certificate asserting that the cryptographic processor complies with a Trusted Computing Platform Alliance (TCPA) specification.

17. The method of claim 15, wherein the identification credential comprises:
a cryptographic processor identity having an identification label and an identification key;
a general description of the cryptographic processor and security services offered by the cryptographic processor;
a general description of a trusted platform/device and security properties for the trusted platform/device, wherein the general description of the trusted platform/device and security properties includes a name of the Certification Authority used to attest to the identity of the data.

18. An article comprising: a secure storage medium having a plurality of machine accessible instructions, wherein when the instructions are executed by a processor, the instructions provide for establishing a single new identity based on trusted hardware components, wherein the single new identity comprises certificates bound together, wherein the certificates indicate that the trusted hardware components conform to a Trusted Computing Platform Alliance (TCPA) specification;
collecting and collating all of the data for the single new identity;
sending the collated data to a Certification Authority to attest to the identity of the data;
performing an attestation check on the data to verify the operation of the single new identity; and
formatting the single new identity into an identification credential, wherein the identification credential is based on trusted hardware to improve the trustworthiness and security of network communications.

19. The article of claim 18, wherein the certificates comprise an endorsement certificate having a public key of a cryptographic public endorsement identity for a cryptographic processor, the cryptographic processor being one component of the trusted hardware components;
a platform credential certificate, the platform credential certificate including a pointer to the endorsement certificate that identifies an endorser of a platform and a platform model of the platform, wherein the platform comprises a component of the trusted hardware components;
a conformance credential certificate, the conformance credential certificate asserting that the cryptographic processor complies with a Trusted Computing Platform Alliance (TCPA) specification.

20. The article of claim 18, wherein the identification credential comprises:
a cryptographic processor identity having an identification label and an identification key;
a general description of the cryptographic processor and security services offered by the cryptographic processor;
a general description of a trusted platform/device and security properties for the trusted platform/device, wherein the general description of the trusted platform/device and security properties includes a name of the Certification Authority used to attest to the identity of the data.

21. A system comprising:
a processor system, the processor system including a cryptographic coprocessor having a trusted software stack, the cryptographic coprocessor and the trusted software stack enabling the generation of an identification credential, a method for generating the identification credential comprising:
establishing a single new identity based on trusted hardware components, wherein the single new identity comprises certificates bound together, wherein the certificates indicate that the trusted hardware components conform to a Trusted Computing Platform Alliance (TCPA) specification;
collecting and collating all of the data for the single new identity;
sending the collated data to a Certification Authority to attest to the identity of the data;
performing an attestation check on the data to verify the operation of the single new identity; and
formatting the single new identity into an identification credential, wherein the identification credential is based on trusted hardware to improve the trustworthiness and security of network communications.

22. The system of claim 21, wherein the certificates comprise an endorsement certificate having a public key of a cryptographic public endorsement identity for a cryptographic processor, the cryptographic processor being one component of the trusted hardware components;
a platform credential certificate, the platform credential certificate including a pointer to the endorsement certificate that identifies an endorser of a platform and a platform model of the platform, wherein the platform comprises a component of the trusted hardware components; and
a conformance credential certificate, the conformance credential certificate asserting that the cryptographic processor complies with a Trusted Computing Platform Alliance (TCPA) specification.

23. The system of claim 21, wherein the identification credential comprises:
a cryptographic processor identity having an identification label and an identification key;
a general description of the cryptographic processor and security services offered by the cryptographic processor;
a general description of a trusted platform/device and security properties for the trusted platform/device, wherein the general description of the trusted platform/device and security properties includes a name of the Certification Authority used to attest to the identity of the data.
